(19) United States
(12) Patent Application Publication
(10) Pub. No.: US 2014/0180695 A1
(43) Pub. Date: Jun. 26, 2014

(54) GENERATION OF CONVERSATION TO ACHIEVE A GOAL

(71) Applicant: Microsoft Corporation, Redmond, WA (US)

(72) Inventors: Brian Beckman, Newcastle, WA (US); Eyal Ofek, Redmond, WA (US)

(21) Appl. No.: 13/726,577

(22) Filed: Dec. 25, 2012

(51) Int. Cl. G10L 13/02

(52) U.S. Cl. CPC G10L 13/02
USPC 704/258

(57) ABSTRACT

Conversation to reach a goal may be created by stitching together pieces of past conversations. Conversations are stored and indexed. A user specifies a goal that the user would like to achieve through conversation. Pieces of conversation that could achieve that goal are retrieved and/or stitched together from smaller conversation fragments, and the resulting conversation pieces are evaluated for merit. The merit evaluator is pluggable so that different merit calculations may be used for various different situations. The conversation may be displayed or spoken to the user as a prompt, so that the user can engage in a real conversation with a real person based on the guidance received. The system can react to the current state of the conversation, and may change conversational strategies or even conversational goals during the course of the conversation.

### BACKGROUND

Generating human speech is a difficult problem. In theory, content in a human language can be generated by a system that knows the grammar, diction, and semantics of the language. In reality, when humans construct sentences they observe certain subtleties, shades of meaning, unspoken conventions, word plays, subtexts, etc., that make their sentences seem smoother and less choppy than those generated by a machine. One solution to the problem of generating content by machine is to store actual human-generated content, and stitch pieces of that content together using an overlap rule. A rule that calls for stitched pieces to overlap to some degree tends to reduce choppiness.

A related problem that presents a further level of complexity is generating an entire conversation between plural participants. In theory, one could simply collect dialog and then stitch together different units of dialog to simulate an entire conversation. However, such a conversation would involve at least one person whose behavior and reactions are unpredictable. No matter how carefully a new conversation is synthesized from existing conversations, the unpredictable behavior of one of the participants could quickly derail the conversation and send it off in a different direction from what has been planned. A system that merely generates content in a human language is unable to react to these types of changes in the conversation.

### SUMMARY

A conversation may be generated by stitching together pieces of an existing conversation. The generated conversation may be used to achieve a goal.

A person may have a goal that he wants to achieve by engaging in an appropriate conversation—e.g., getting a job, getting a raise, convincing a criminal suspect to confess, etc. Many conversations to achieve these goals (or other goals) have already taken place. These conversations may be harvested, stored, and indexed. When a user requests to achieve a goal, an abstract path to the goal is created. For example, to get a raise, the path might first be to greet the boss, then flatter the boss, then talk about one's own strengths, then ask for the raise. When the path is planned, stored pieces of conversations that move toward the goal may be retrieved, and these pieces of conversations may be stitched together to form a hypothetical conversation that will achieve the goal. Different possible conversations may be evaluated according to a pluggable merit function that evaluates the merit of different possible versions of the conversation. The conversation may then be presented to the user as a prompt. For example, a script for the conversation may be shown to the user on a computer screen. Or, for a live conversation in which the user wants to hide the fact that his conversation is being scripted, the script may be shown in a small monitor hidden in the user's glasses, or spoken to the user through an earpiece.

As the conversation changes, the path toward the goal—or even the goal itself—may change. Thus, with each “volley” in the conversation, the system may reevaluate the current state of the conversation, and may choose a new path toward the goal, revising the script accordingly. Moreover, in some cases the conversation may take such a severe turn that the goal of the conversation itself changes. E.g., if the initial goal of the conversation is to get a raise, and the boss reveals that budget cuts are about to cause layoffs, the goal may abruptly change from getting a raise to not getting fired.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a flow diagram of an example process in which source material on conversations may be collected.

FIG. 2 is a flow diagram of an example process of generating a conversation based on stored conversations.

FIG. 3 is a flow diagram of an example process of generating and choosing the travesties.

FIG. 4 is a view of some example devices that may be used to communicate conversation prompts to a user.

FIG. 5 is a block diagram of example components that may be used in connection with implementations of the subject matter described herein.

### DETAILED DESCRIPTION

Synthesizing content in a human language is a difficult problem. The basic grammar of human language can be understood—e.g., a sentence contains a noun and a verb, possibly an object, possibly a prepositional phrase, etc. However, simply putting together words that follow the rules of grammar often results in artificial, choppy-sounding sentences. The reason that the sentences sound artificial is that humans often take context into account when deciding what to say or write. These contexts often have subtleties that cannot easily be modeled for use by a machine. Thus, systems that synthesize human language content often do so by splicing together overlapping fragments of sentences that have previously been created by people. In effect, this type of synthesis bypasses true machine understanding of the language, and instead leverages human understanding of the language by simply copying (in a modified, stitched-together form) content that people have already created in the language.

Creating a conversation synthetically presents an additional level of complexity beyond merely creating human language content. In a conversation between two participating parties, in order to know what party A is supposed to say, one has to know what party B says. Even if party A has planed exactly what he will say, party B's responses are not wholly predictable, so party A's plans can easily be derailed during the course of the conversation based on what party B says or does. Thus, a system that synthesizes a conversation not only has to be able to splice together conversation fragments into a coherent conversation, but also has to react to what another party is saying.

A person might want to synthesize a conversation as a guide to reaching a goal. For example, one might want help asking for a raise, or making a sales pitch, or interviewing for a job, or convincing a criminal suspect to confess. There are business texts that educate people in the art of negotiation. Books are useful guides to a conversation, but the guidance could be taken to a higher level if the person could have a teleprompter or audio-prompter (e.g., one hidden in a person's glasses, or in an earpiece) that tells a person, in real time, what to say to reach a goal.

The subject matter described herein provides a way to synthesize a conversation in order to reach a goal. Existing conversations are stored and indexed, so that the conversations can be retrieved. A system can be created that, given some goal, retrieves conversation fragments and stitches the fragments together in a way that works toward the goal. The system takes into account the notion of a “state” of the conversation. Given a state and a goal, the system can evaluate the merit of any proposed path. In general, the function evaluates merit based on how well a particular path works toward the goal. However, the function that is used to evaluate merit can be pluggable, so that different models of what constitutes merit can be used, and so that the system can accommodate many different substantive types of conversations.

As the system operates, it generates travesties, which are paths generated from conversation fragments. Given the current state and the goal, the merit function is used to evaluate the merit of a particular travesty. One of the travesties may be chosen based on weighted randomness—e.g., if travesty A has a merit of 0.4 and travesty B has a merit of 0.6, then one of the travesties may be chosen at random, but with a probability distribution that favors travesty B by 6-to-4 odds (since travesty B has more merit than travesty A by a ratio of 6:4). Choosing a conversation in this way allows the merit of different paths to be taken into account, while also introducing some variability into the conversation. Once the particular travesty is chosen, the proposed conversational content represented by the travesty (e.g., a particular sequence of statements or questions that a person is to say) is presented to the person. This presentation might be on a computer screen, a screen hidden in the user's glasses, or an audio prompt delivered through an earpiece. The person can then say the words that he is prompted to say. The travesties that are chosen might not be those that receive the highest merit scores, since the highest-scoring travesties are likely to be very similar to each other. Rather, the system might look for, say, three travesties chosen to achieve some level of variance in the sample, so that there are several divergent conversational paths to choose from.

As noted above, a conversation involves at least two people, and the state of the conversation—or even its goal—can change based on the other person's response. For example, if a person is trying to achieve the goal of getting a raise, then a system might suggest that a person say to his boss, “I would like a raise,” at which point the “state” of the conversation might be “question posed.” The system might have predicted that the boss would say, “Okay, look for a raise in next week's paycheck.” However, if instead the boss says, “we're facing budget cutbacks and considering layoffs,” then the new state of the conversation might change to “negative response”. Even the goal might change—e.g., the old goal of “get a raise” might become “keep from getting fired.” At this point, the system can generate a new travesty given the new current state (and, possibly, given the new goal), and can give the person directions from that point on what to say.

As the system generates conversation prompts, it can take into account various factors. For example, the system might want to ensure that each statement a person makes is consistent with all past statements. In effect, consistency can be addressed through a merit function, where consistency is simply one factor that goes into the merit calculation. In some conversations, consistency might not be expected; e.g., in a criminal interrogation, a conversation might contain many inconsistencies, as the interrogator is attempting to trap the suspect in a lie. It is noted, however, that consistency is a concept that can be defined differently for different conversations. In one example, recordings of actual, organic conversations may be considered to be “consistent”, and the consistency of a conversation that is taking place may be judged by how long a path it follows along a prior, known conversation. Thus, in a criminal interrogation that appears, on its surface, to contain contradictory statements, the contradictions might be considered normal for this type of conversation, in which case the consistency of a new criminal interrogation might be judged based on how closely it tracks a prior interrogation that was presumed to be internally consistent.

Generating a conversation in the way described above involves having a database of existing conversations, so that pieces of existing conversations can be stitched together. Existing conversations might be mined from transcripts of real conversations—e.g., recorded audio conversations, computer chat room conversations, court recordings, call center recordings, recordings of reality television shows, or recordings from people who have volunteered to wear voice recorders, etc. In another example, conversations can be mined from sample conversations—e.g., conversations that appear in a text on the art of negotiation. As another example, after a system that advises people on conversations has been in place for some time, the conversations that take place under the direction of that system can, themselves, be mined as sources of conversation data for future use. (Actual conversations that take place under the direction of the system may be a particularly relevant source of raw data about conversations. This is so because there may be a certain amount of skill involved in applying the conversational advice that is given, so data about real conversations that have taken place under direction can provide not only information about the conversation itself, but also information about how successful particular directions were at guiding the user toward a goal.)

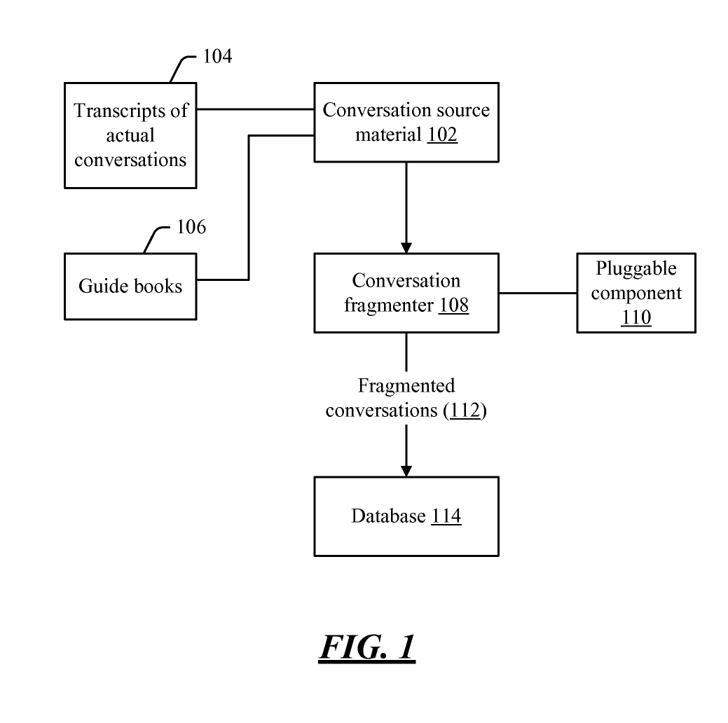

Turning now to the drawings, FIG. 1 shows an example process in which source material on conversations may be collected. The process starts with conversation source material 102. Examples of such source material include transcripts of actual conversations (block 104) and guide books (block 106). Actual conversations may take the form of written conversations (e.g., conversations that occur in online chat rooms), or spoken conversations. In the case of spoken conversations, voice recognition software may be used to transcribe the conversation. Guide books include books on how to achieve certain goals, such as the books mentioned above on the art of negotiation in business. The foregoing are some examples of conversation sources, although any appropriate sources may be used. In particular, once a system to guide a person's conversation (such as the system described herein) has been in place for a sufficient amount of time, the guided conversations themselves may provide conversation source material.

The conversation source material may then be provided to a conversation fragmenter 108. Conversation fragmenter breaks conversation into atomic units. It is noted that fragmentation is optional, and the act of determining what constitutes a fragment may be deferred until an actual conversation has deferred from one of the recordings. That is, real conversations may be stored in the database in an unfragmented state, and the issue of how many units of two conversations overlap (or what constitutes a unit of conversation) may be deferred until two conversations have to be stitched together. The concept of fragmentation is thus described here, but it will be understood that the subject matter described herein covers both systems that pre-fragment the stored conversations, and those that do not. The problem of synthesizing human language content, which was described at the beginning of this section, typically treats words as being the atomic units from which sentences can be stitched together. In the case of synthesizing conversation, each “volley” in the conversation (whether a single word, a single sentence, or multiple sentences) might be treated as the atomic unit. For example, in a conversation to achieve a raise, the words, “Hello, boss. I think I've done really good work. Can I have a raise?” might be treated as a single atomic unit, even though it contains several words and more than one sentence. However, there are other ways to fragment a conversation—e.g., the conversation might be fragmented sentence by sentence. The purpose of fragmenting a conversation into atomic units is to allow the units to be stitched together according to some set of rules. For example, fragments that have some amount of overlap tend to sound less artificial and disjointed when stitched together, and if the stitching rule calls for, say, three overlapping fragments, then one has to have a clear sense of what constitutes an atomic fragment.

The process of fragmenting a conversation may be made flexible through the use of a pluggable component 110. Pluggable component 110 defines how to divide a conversation into fragments, and effectively defines what constitutes a fragment and what the equivalence classes of fragments are. For example, in a two-person conversation, pluggable component 110 may recognize each “volley” in the conversation as a fragment. Moreover, pluggable component might recognize certain conversation fragments as being equivalent to each other. For example, “hi”, “hello”, and “how are you” are contain different words, but each of these phrases might be understood as a “greeting” fragment. Similarly, “Can I have a raise?”, “I would like an increase in compensation,” and “Show me the money!” might all be understood as a “request for raise” fragment. As discussed below, there might be reasons to choose one of these phrases over another when guiding an actual conversation, since each phrase sets a different tone to express the same thought. However, for the purpose of fragmenting and categorizing the different phrases that occur in a conversation, these phrases might be understood to be equivalent to each other on some level.

It is noted that pluggable component 110 can be implemented to recognize any concept of a fragment. For example, the analysis of a police interrogation might be substantively different from that of a job interview, and different components could be used to analyze and fragment these conversations. It is the use of pluggable component 110 that makes the process of FIG. 1 extendible to a wide variety of conversational situations.

The conversations (either the original conversation source material 102, or the fragmented conversations 112 in the case of pre-fragmenting) may be stored in database 114. The conversations may later be used to stitch together a new conversation as part of guiding a person toward a goal.

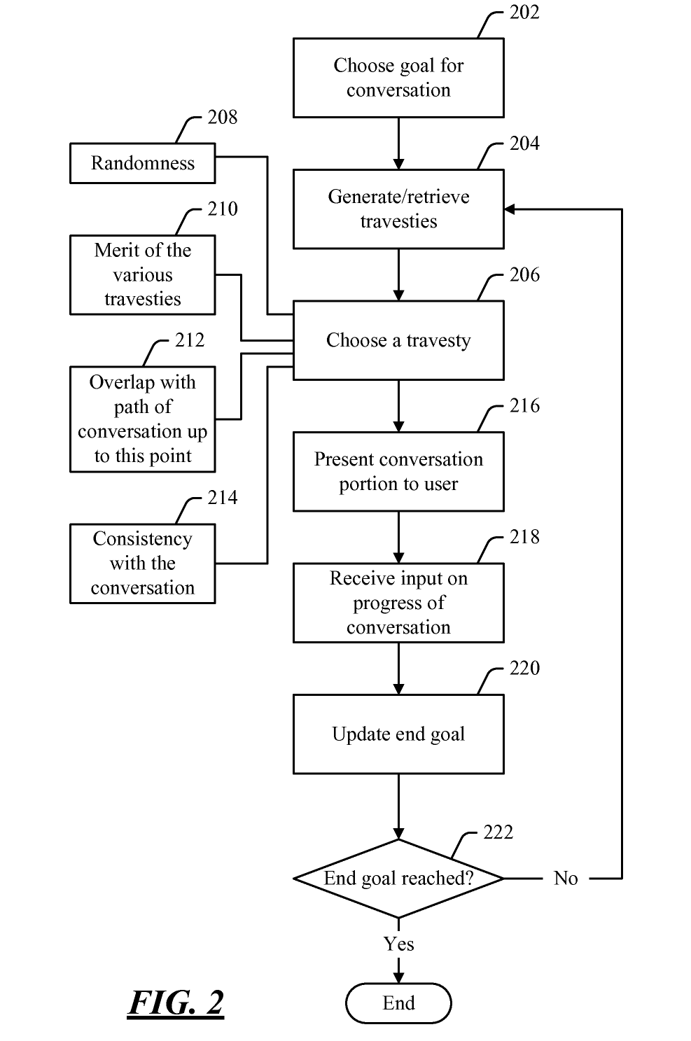

FIG. 2 shows an example process of generating a conversation based on stored conversations.

At 202, a goal for the conversation is chosen. For example, the goal might be getting a raise, getting a lower price on a new car, interviewing for a job, convincing someone to go on a date, etc. At 204, travesties may be generated from conversations in a database, or may be retrieved from the database. (The database may be database 114, shown in FIG. 1.) Each travesty is a conversation, or a sequence of conversation fragments, that have been stitched together, and that have been determined to move the current state of the conversation closer to the goal. Example considerations for choosing or stitching together travesties are discussed below in connection with block 206. For the purpose of FIG. 2, however, it is assumed that there is some way of choosing travesties, or combining existing conversation fragments to form a travesty.

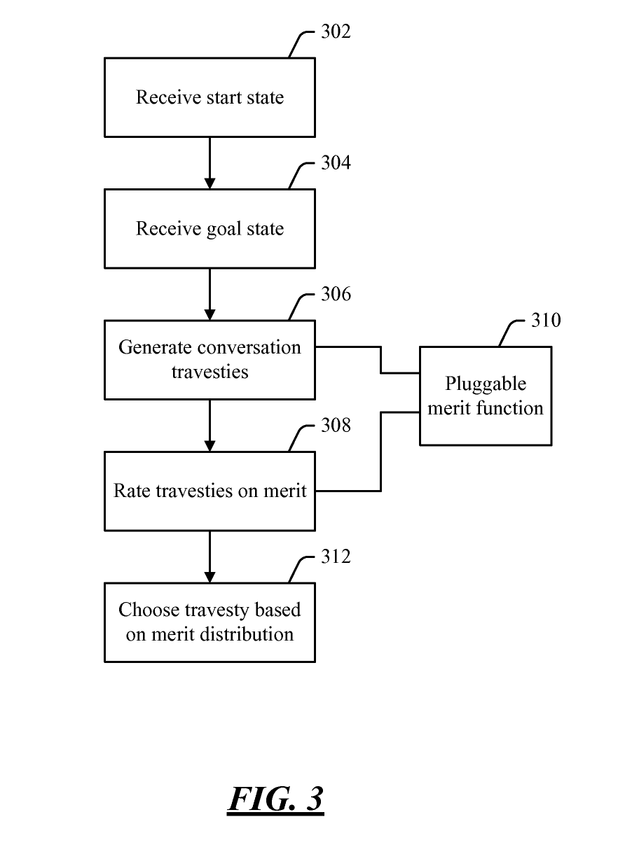

At 206, one of the retrieved or generated travesties is chosen. There is a way to evaluate the merit of a travesty, using a pluggable merit function that is described below in connection with FIG. 3. For example, if the goal is interviewing for a job, one travesty might be the sequence: “Job-seeker: Hello; Interviewer: Hello. Tell me about your qualifications; Job-seeker: I have worked in retail for two years . . . .” Another travesty might be the sequence: “Job-seeker: Boy do I have a deal to offer you! Interviewer: Really, how so? Job-seeker: I'll do twice the work for half the price!” Either of these conversations might lead closer to the goal of getting a job, but one might have more “merit” than another—e.g., the first one might have a merit of 0.75, while the second one might have a merit of 0.25, according to some merit algorithm. Thus, at 206 one of the travesties is chosen based on criteria such as those shown in blocks 208-214.

Blocks 208-214 show some example considerations that may be used to choose among the travesties. Blocks 208 and 210 indicate that both randomness and merit are used to make the choice. For example, if the two travesties have merit scores of 0.75 and 0.25, then one of these two travesties might be chosen according to a probability mass function that has 3:1 odds of choosing the first travesty (reflecting the fact that the first travesty has been determined to have three times as much merit as the second). Thus, the merit influences the way that a travesty is chosen, but—in order to introduce some variability into a guided conversation—there is still a small chance that an inferior travesty would be chosen over a more meritorious one.

Blocks 212 and 214 indicate other criteria that may be used. For example, one criterion that may be used to choose a travesty is whether, and to what extent, it has fragments that overlap with the previous fragments in the conversation (block 212). As discussed elsewhere herein, stitching together overlapping portions of a conversation may cause the synthesized product to seem less disjointed, and more natural, that it otherwise would. Another factor that may be considered in choosing a travesty is whether the conversation in the travesty contradicts the previous portions of the conversation. In some cases, consistency is a virtue—e.g., if one has previously said, “I hate baseball,” then saying “I like baseball” later in the conversation might make the speaker sound unbalanced. On the other hand, sometimes inconsistency is a virtue—e.g., in a criminal interrogation, an interrogator might use inconsistencies to try to trip up the suspect in a lie, and one would expect a lying suspect to state many inconsistencies in his portion of the conversation. Consistency cannot be said to be universally a virtue or a vice; it depends on the type of conversation that is being conducted. It is noted that the considerations at blocks 212 and 214 may be considered as part of the merit function. One way to provide consistency across conversations is to verify that stitched conversations maintain some level of consistency for some range around the stitch point. That is, if two conversations have been determined to be internally consistent, and if they are similar to each other for a range around the point at which the conversations are stitched, then the stitched conversation may be presumed to be consistent.

At 216, a conversation fragment based on the chosen travesty may be presented to the user. For example, if the user is in front of his computer conducting a telephone conversation, the conversation fragment may be displayed on the computer screen. If the user is conducting a video conversation, then the conversation may be displayed in a text overlay. If the user is conducting a conversation in person, the conversation may be presented through a display hidden in the user's glasses, or spoken through an earpiece.

At 218, input on the progress of the conversation is received. For example, the other party's response to the conversation may be captured, and may be compared with the ending state of the chosen travesty to determine whether the conversation moved in the predicted direction. Depending on how far the conversation moved from the predicted direction, the end goal of the conversation might be updated (at 220). For example, as noted above, a conversation that starts with the goal of getting a raise might reveal that the company is considering layoffs; in that case, the goal might switch from “get a raise” to “avoid getting fired.”

At 222, it is determined if the end goal of the conversation has been reached. If the end goal has been reached, then the process terminates. If the end goal has not been reached, then the process returns to 204 to generate or retrieve another travesty that will bring the conversation closer to the (possibly updated) end goal.

As noted above, part of the process of proposing a conversation involves generating travesties and choosing from among the travesties. FIG. 3 shows an example process of generating and choosing the travesties. It is noted that one purpose of generating travesties is to prevent exponential growth that would result if one had to generate all possible paths from the current state of a conversation. Generation of travesties based on which ones satisfy some merit criteria, and then choosing from among the travesties, allows the set of possible paths to be offered to a user to be winnowed down to a small, manageable number of possibilities. (Generating travesties also allows the number of possible paths to be restricted to conversations that have the potential to be valid. Generating every possible combination of conversation fragments would generate many conversations that are nonsensical, or otherwise invalid.)

At 302, the start state of the conversation is received. The start state may be the initial state that exists at the outset of a conversation, or it may be the current point that the conversation has reached after some amount of progress. At 304, the goal state of the conversation is received.

At 306, travesties are generated based on the starting state and the goal. That is, travesties are generated that tend to bring the current state closer to the end goal. At 308, the generated travesties are rated based on merit. The generation of travesties, and/or the rating of the generated travesties, may be performed using a pluggable merit function 310. The merit function effectively receives the starting state and the ending state and calculates a score. As noted above, there may be various criteria that are used in a merit function depending on context—e.g., number of fragments that overlap with the conversational path leading up to the current state, consistency with the prior parts of the conversation, effectiveness at reaching the end goal, consistency with the user's chosen style (e.g., aggressive, polite, manipulative, etc.). Any criteria may be used to rate a travesty on merit.

Once some number of travesties has been generated, a particular one of the travesties may be chosen based on the distribution of merit and a random factor (at 312). As described above, if a first travesty has a merit of 0.75 and a second has a merit of 0.25, then one of the two travesties may be chosen randomly, but in a way that makes the first travesty three times more likely to reflect the fact that it has three times as much merit. (One way to introduce randomness into the choice of travesty is Walker's Method of Aliases.) As noted above, the actual travesties that are chosen may be chosen to have some level of variance from each other, rather than merely choosing the highest scoring travesties. For example, a k-means technique may be used, where travesties are divided into k clusters characterized by divergent features, and the highest-scoring travesty from each cluster is chosen.

It is noted that, as an alternative to generating several travesties and randomly choosing between them, a system could use the merit function to generate a single travesty. Moreover, the merit function could incorporate some randomness, thereby achieving the same effect as randomly choosing between several travesties.

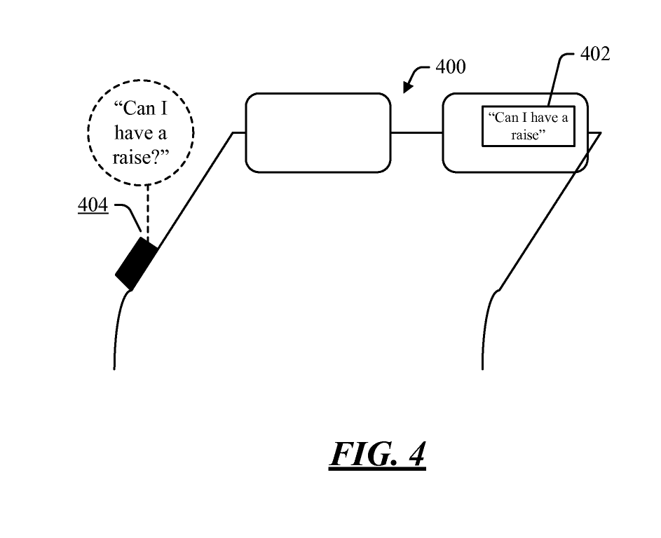

As noted above, one goal of generating conversations is to advise a person as to how to achieve a goal. Thus, when the conversation is generated, it normally has to be communicated to the person so that the person can use it to achieve the goal. FIG. 4 shows some example devices that may be used to communicate conversation prompts to a user.

Device 400 is a pair of glasses with a display 402 and an earpiece 404. A user may wear device 400. Device 400 may be communicatively connected (e.g., via WiFi) to a device that generates the conversation, or the computational logic to generate a conversation may be built into device 400.

While the user wears device 400, the user may see conversational prompts on display 402, or may hear conversational prompts through earpiece 404. In the example shown, the user may see or hear the words, “Can I have a raise?” It is noted that device 400 is merely an example. In another example, a device has only the small display 402 hidden in the user's glasses, or only the earpiece 404 (which may or may not be part of an eyeglass frame). In yet another example, the user simply reads the conversational prompts on a computer monitor while the user makes a phone call. In yet another example, the conversational prompts may be converted to text to be sent to another party, thereby effectively allowing a computer to have a conversation by pretending to be a person.

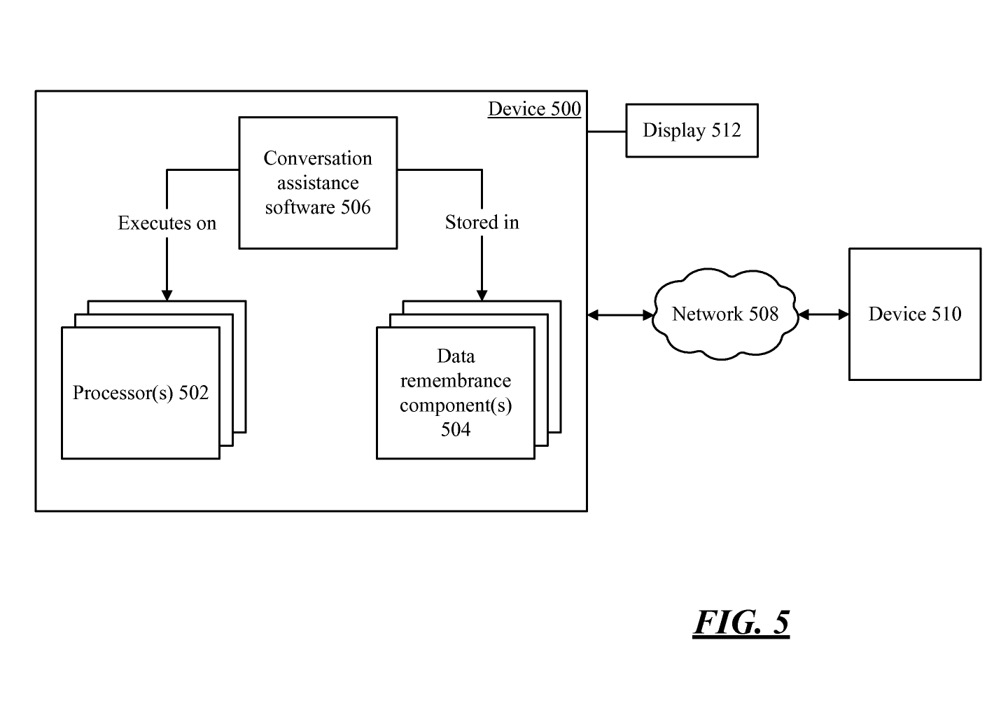

FIG. 5 shows an example environment in which aspects of the subject matter described herein may be deployed.

Device 500 includes one or more processors 502 and one or more data remembrance components 504. Device 500 may be any type of device with some computing power. A smart phone is one example of device 500, although device 500 could be a desktop computer, laptop computer, tablet computer, set top box, or any other appropriate type of device. Processor(s) 502 are typically microprocessors, such as those found in a personal desktop or laptop computer, a server, a handheld computer, or another kind of computing device. Data remembrance component(s) 504 are components that are capable of storing data for either the short or long term. Examples of data remembrance component(s) 504 include hard disks, removable disks (including optical and magnetic disks), volatile and non-volatile random-access memory (RAM), read-only memory (ROM), flash memory, magnetic tape, etc. Data remembrance component(s) are examples of computer-readable (or device-readable) storage media. Device 500 may comprise, or be associated with, display 512, which may be a cathode ray tube (CRT) monitor, a liquid crystal display (LCD) monitor, or any other type of monitor. Display 512 may be an output-only type of display; however, in another non-limiting example, display 512 may be (or comprise) a touch screen that is capable of both displaying and receiving information.

Software may be stored in the data remembrance component(s) 504, and may execute on the one or more processor(s) 502. An example of such software is conversation assistance software 506, which may implement some or all of the functionality described above in connection with FIGS. 1-4, although any type of software could be used. Software 506 may be implemented, for example, through one or more components, which may be components in a distributed system, separate files, separate functions, separate objects, separate lines of code, etc. A device (e.g., smart phone, personal computer, server computer, handheld computer, tablet computer, set top box, etc.) in which a program is stored on hard disk, loaded into RAM, and executed on the device's processor(s) typifies the scenario depicted in FIG. 5, although the subject matter described herein is not limited to this example.

The subject matter described herein can be implemented as software that is stored in one or more of the data remembrance component(s) 504 and that executes on one or more of the processor(s) 502. As another example, the subject matter can be implemented as instructions that are stored on one or more device-readable media. Such instructions, when executed by a phone, a computer, or another machine, may cause the phone, computer, or other machine to perform one or more acts of a method. The instructions to perform the acts could be stored on one medium, or could be spread out across plural media, so that the instructions might appear collectively on the one or more computer-readable (or device-readable) media, regardless of whether all of the instructions happen to be on the same medium.

Computer-readable media includes, at least, two types of computer-readable media, namely computer storage media and communication media. Likewise, device-readable media includes, at least, two types of device-readable media, namely device storage media and communication media.

Computer storage media (or device storage media) includes volatile and non-volatile, removable and non-removable media implemented in any method or technology for storage of information such as computer readable instructions, data structures, program modules, or other data. Computer storage media (and device storage media) includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that may be used to store information for access by a computer or other type of device.

In contrast, communication media may embody computer readable instructions, data structures, program modules, or other data in a modulated data signal, such as a carrier wave, or other transmission mechanism. As defined herein, computer storage media does not include communication media. Likewise, device storage media does not include communication media.

Additionally, any acts described herein (whether or not shown in a diagram) may be performed by a processor (e.g., one or more of processors 502) as part of a method. Thus, if the acts A, B, and C are described herein, then a method may be performed that comprises the acts of A, B, and C. Moreover, if the acts of A, B, and C are described herein, then a method may be performed that comprises using a processor to perform the acts of A, B, and C.

In one example environment, device 500 may be communicatively connected to one or more other devices through network 508. device 510, which may be similar in structure to device 500, is an example of a device that can be connected to device 500, although other types of devices may also be so connected.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A device-readable medium that stores executable instructions to generate a conversation, the executable instructions, when executed by a device, causing the device to perform acts comprising:
receiving a first goal for said conversation;
from conversations stored in a database, creating or retrieving a travesty that represents a portion of said conversation that moves a current state of said conversation closer to said first goal, said conversations comprising actual conversations or sample conversations, said travesty satisfying a merit criterion calculated by a pluggable merit function; and
providing said portion of said conversation to a user as a conversational prompt.

2. The device-readable medium of claim 1, said travesty satisfying a criterion as to a number of fragments in which said travesty overlaps with a prior portion of said conversation.

3. The device-readable medium of claim 1, said travesty satisfying a criterion that said travesty is to be consistent with a prior portion of said conversation.

4. The device-readable medium of claim 1, said acts further comprising:
receiving a response to said portion of said conversation from another person who participates in said conversation; and
changing said first goal to a second goal based on said response.

5. The device-readable medium of claim 1, said creating or retrieving of said travesty comprising:
generating a plurality of travesties;
calculating merit scores for each of said travesties; and
choosing said travesty from among said travesties randomly using a distribution that is based on said merit scores.

6. The device-readable medium of claim 1, said providing of said portion of said conversation comprising:
displaying said portion of said conversation in a monitor that is hidden in glasses that said user wears.

7. The device-readable medium of claim 1, said providing of said portion of said conversation comprising:
providing said portion of said conversation as audio in an earpiece that said user wears.

8. A method of generating a first conversation, the method comprising:
using a processor to perform acts comprising:
receiving source material containing a plurality of second conversations;
using a pluggable component to divide said second conversations into fragments and to index said fragments;
storing indexed fragments of said second conversations in a database;
receiving a first goal for said first conversation;
from indexed fragments stored in said database, creating or retrieving a travesty that represents a portion of said first conversation that moves a current state of said first conversation closer to said first goal, said travesty satisfying a merit criterion calculated by a pluggable merit function; and
providing said portion of said first conversation to a user as a conversational prompt.

9. The method of claim 8, said travesty satisfying a criterion as to a number of fragments in which said travesty overlaps with a prior portion of said first conversation.

10. The method of claim 8, said travesty satisfying a criterion that said travesty is to be consistent with a prior portion of said first conversation.

11. The method of claim 8, said acts further comprising:
receiving a response to said portion of said first conversation from another person who participates in said first conversation; and
changing said first goal to a second goal based on said response.

12. The method of claim 8, said creating or retrieving of said travesty comprising:
generating a plurality of travesties;
calculating merit scores for each of said travesties; and
choosing said travesty from among said travesties randomly using a distribution that is based on said merit scores.

13. The method of claim 8, said providing of said portion of said first conversation comprising either:
displaying said portion of said first conversation in a monitor that is hidden in glasses that said user wears; or
providing said portion of said first conversation as audio in an earpiece that said user wears.

14. A device for generating a conversation, the device comprising:
a memory;
a processor;
a database; and
a component that is stored in said memory, that executes on said processor, that receives a first goal for said conversation, that uses conversations stored in said database to create or retrieve a travesty that represents a portion of said conversation that moves a current state of said conversation closer to said first goal, said conversations comprising actual conversations or sample conversations, said travesty satisfying a merit criterion calculated by a pluggable merit function, said device providing said portion of said conversation to a user as a conversational prompt.

15. The device of claim 14, said travesty satisfying a criterion as to a number of fragments in which said travesty overlaps with a prior portion of said conversation.

16. The device medium of claim 14, said travesty satisfying a criterion that said travesty is to be consistent with a prior portion of said conversation.

17. The device medium of claim 14, said component receiving a response to said portion of said conversation from another person who participates in said conversation, said component changing said first goal to a second goal based on said response.

18. The device of claim 14, said component creating or retrieving said travesty by generating a plurality of travesties, calculating merit scores for each of said travesties, and choosing said travesty from among said travesties randomly using a distribution that is based on said merit scores.

19. The device of claim 14, further comprising:
glasses with a monitor hidden in said glasses, said user wearing said glasses, said component providing said portion of said conversation by displaying said portion of said conversation in said monitor.

20. The device of claim 14, further comprising:
an earpiece that said user wears, said component providing said portion of said conversation by providing said portion of said conversation as audio in said earpiece.
